(19) United States
(12) Patent Application Publication
(10) Pub. No.: US 2025/0307790 A1
(43) Pub. Date: Oct. 2, 2025

(54) APPARATUS FOR CONTROLLING A VEHICLE, SYSTEM FOR PROVIDING E-COMMERCE SERVICE, AND METHOD THEREOF

(71) Applicants: HYUNDAI MOTOR COMPANY, Seoul (KR); Kia Corporation, Seoul (KR)

(72) Inventor: Young Seok JO, Hwaseong-si (KR)

(73) Assignees: HYUNDAI MOTOR COMPANY, Seoul (KR); Kia Corporation, Seoul (KR)

(21) Appl. No.: 18/816,296

(22) Filed: Aug. 27, 2024

(30) Foreign Application Priority Data
Mar. 26, 2024 (KR) 10-2024-0041284

(51) Int. Cl. G06Q 20/12; B60K 35/22; G06Q 20/18; G06Q 30/0251

(52) U.S. Cl. CPC G06Q 20/123; B60K 35/22; G06Q 20/18; G06Q 30/0265

(57) ABSTRACT

A method for providing an e-commerce service through communication in a terminal of a user who utilizes a vehicle including a vehicle control apparatus and a server of a platform, may include posting, by the server, pieces of content for communication or expression, the pieces of content being uploaded to the server, to the user by the terminal, paying, by the terminal, a price of content selected by a user input among the pieces of posted content, transmitting, by the terminal, a request for obtaining the paid content to the server, providing, by the server, a seller who uploads the paid content with an amount corresponding to a portion or all of the price, transmitting, by the server, the paid content to the vehicle control apparatus, and displaying, by the vehicle control apparatus, the paid content to the outside of the vehicle.

### CROSS-REFERENCE TO RELATED APPLICATION

The present application claims priority to Korean Patent Application No. 10-2024-0041284, filed on Mar. 26, 2024, the entire contents of which is incorporated herein for all purposes by this reference.

### BACKGROUND OF THE PRESENT DISCLOSURE

### Field of the Present Disclosure

The present disclosure relates to a vehicle control apparatus, a system for providing an electronic commerce (e-commerce) service, and a method thereof, and more particularly, relates to technologies for transacting content displayed on the vehicle control apparatus.

### Description of Related Art

With the development of mobility technology and display technology, an external display technology to identify displayed contents of a display from the outside of a vehicle has been developed.

An external display may provide a clear image, using a high-resolution screen, and may rapidly and intuitively deliver a message to a surround driver or a surrounding pedestrian. To increase the performance of the external display, the effort of increasing resolution, durability, water resistance, and energy consumption efficiency of the external display is performed.

Furthermore, it is expected to increase the demand of a consumer for obtaining various pieces of content from pieces of content to be displayed on the external display and displaying the pieces of content in various manners.

The information included in the present Background of the present disclosure section is only for enhancement of understanding of the general background of the present disclosure and may not be taken as an acknowledgement or any form of suggestion that the present information forms the prior art already known to a person skilled in the art.

### BRIEF SUMMARY

Various aspects of the present disclosure are directed to providing a vehicle control apparatus for transacting content displayed on a vehicle.

Examples of the present disclosure provide a system for providing an e-commerce service for transacting content displayed on a vehicle and a method thereof.

Examples of the present disclosure provide a vehicle control apparatus for displaying content for communication or expression, which is effective and emotional.

Examples of the present disclosure provide a system for providing an e-commerce service for transacting content for communication or expression, which is effective and emotional, and a method thereof.

Examples of the present disclosure provide a system for providing an e-commerce service for allowing a platform to ensure big data by brokering the transaction of content displayed on a vehicle and a method thereof.

Examples of the present disclosure provide a system for providing an e-commerce service for ensuring a communication ecosystem between vehicles by brokering the transaction of content displayed on a vehicle and a method thereof.

Examples of the present disclosure provide a system for providing an e-commerce service for allowing a platform to ensure a profit by brokering the transaction of content displayed on a vehicle and a method thereof.

Examples of the present disclosure provide a system for providing an e-commerce service for allowing a seller to ensure a profit by selling content displayed on a vehicle and a method thereof.

Examples of the present disclosure provide a system for providing an e-commerce service for allowing a user to ensure a profit by advertising content displayed on a vehicle and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a system for providing an e-commerce associated with a vehicle control apparatus may include a terminal of a user who utilizes a vehicle including the vehicle control apparatus and a server of a platform.

According to an exemplary embodiment of the present disclosure, the terminal may pay a price of content selected by a user input among pieces of content for communication or expression, the pieces of content posted to the user by the server, and may transmit a request for obtaining the paid content to the server. The server may post pieces of content uploaded to the server to the user by the terminal, provide a seller who uploads the paid content with an amount corresponding to a portion or all of the price and may transmit the paid content to the vehicle control apparatus. The vehicle control apparatus may display the paid content to an outside of the vehicle by a display of the vehicle.

According to an exemplary embodiment of the present disclosure, the terminal may pay the price of the selected content among the pieces of content including at least one of a symbol indicating an intention of the user, information indicating the intention of the user, a symbol associated with safety, information associated with the safety, a symbol for a profit of the user, information for the profit of the user, a symbol for performing decoration or styling of the vehicle, or information for performing the decoration or the styling of the vehicle, or any combination thereof.

According to an exemplary embodiment of the present disclosure, if the selected content includes at least one of a symbol for a profit of the user or information for the profit of the user, or any combination thereof, the terminal may transmit a request for obtaining the selected content to the server, without paying the price of the selected content, and the server may provide the user registered in the terminal with a price of displaying the selected content on the display, without providing the seller with the amount corresponding to the portion or all of the price.

According to an exemplary embodiment of the present disclosure, the server may perform at least one of charging the user a fee, charging the seller the fee, or obtaining cost for an advertisement posted on the platform from an advertiser, or any combination thereof, in a process of brokering and managing a transaction between the seller and the user.

According to an exemplary embodiment of the present disclosure, the terminal may pay the price of the content selected by the user input, based on execution of an application for providing the content, and may transmit the request for obtaining the paid content to the server, based on the execution of the application.

According to an exemplary embodiment of the present disclosure, the server may classify the user as at least one category, based on personal information of the user, and may recommend the pieces of content to the user, based on a frequency at which users included in the at least one category and different from the user pay for the pieces of content. The terminal may post the pieces of recommended content to the user.

According to an exemplary embodiment of the present disclosure, the vehicle control apparatus may display content specified based on an input of a passenger of the vehicle through a user interface among pieces of content stored in the vehicle control apparatus on the display and may provide the passenger with a state in which the specified content is displayed on the display.

According to an exemplary embodiment of the present disclosure, the server may collect or analyze information indicating the user and information related to details in which the user pays the price of the content.

According to an exemplary embodiment of the present disclosure, the vehicle control apparatus may receive the paid content from the server via a vehicle communication device for performing wireless or wired communication of the vehicle.

According to an exemplary embodiment of the present disclosure, the system may further include terminals of a plurality of sellers. The terminals of the sellers may upload the pieces of content for communication or expression to the server for sale.

According to an exemplary embodiment of the present disclosure, if the price of the selected content is free, the terminal may transmit a request for obtaining the selected content to the server, without paying the price of the selected content, and the server may transmit the selected content to the vehicle control apparatus, without providing the seller with the amount corresponding to the portion or all of the price.

According to an exemplary embodiment of the present disclosure, the terminal of the seller included in the terminals of the plurality of sellers may upload custom-made request content included in the pieces of content and requested from the user to the server or deliver the request content to the user.

According to another aspect of the present disclosure, a method for providing an e-commerce service through communication in a terminal of a user who utilizes a vehicle including a vehicle control apparatus and a server of a platform may include posting, by the server, pieces of content for communication or expression, the pieces of content being uploaded to the server, to the user by the terminal, paying, by the terminal, a price of content selected by a user input among the pieces of posted content, transmitting, by the terminal, a request for obtaining the paid content to the server, providing, by the server, a seller who uploads the paid content with an amount corresponding to a portion or all of the price, transmitting, by the server, the paid content to the vehicle control apparatus, and displaying, by the vehicle control apparatus, the paid content to an outside of the vehicle by a display of the vehicle.

According to an exemplary embodiment of the present disclosure, the paying of the price of the content selected by the user input among the pieces of posted content by the terminal may include paying, by the terminal, the price of the content selected by the user input among the pieces of content including at least one of a symbol indicating an intention of the user, information indicating the intention of the user, a symbol associated with safety, information associated with the safety, a symbol for a profit of the user, information for the profit of the user, a symbol for performing decoration or styling of the vehicle, or information for performing the decoration or the styling of the vehicle, or any combination thereof.

According to an exemplary embodiment of the present disclosure, the method may further include, if the selected content includes at least one of a symbol for a profit of the user or information for the profit of the user, or any combination thereof, transmitting, by the terminal, a request for obtaining the selected content to the server, without paying the price of the selected content, and providing, by the server, the user registered in the terminal with a price of displaying the selected content on the display, without providing the seller with the amount corresponding to the portion or all of the price.

According to an exemplary embodiment of the present disclosure, the method may further include performing, by the server, at least one of charging the user a fee, charging the seller the fee, or obtaining cost for an advertisement posted on the platform from an advertiser, or any combination thereof, in a process of brokering and managing a transaction between the seller and the user.

According to an exemplary embodiment of the present disclosure, the paying of the price of the content selected by the user input among the pieces of posted content by the terminal may include paying, by the terminal, the price of the content selected by the user input, based on execution of an application for providing the content. The transmitting of the request for obtaining the paid content to the server by the terminal may include transmitting, by the terminal, the request for obtaining the paid content to the server, based on the execution of the application.

According to an exemplary embodiment of the present disclosure, the posting of the pieces of content for communication or expression, the pieces of content being uploaded to the server, to the user by the terminal by the server may include classifying, by the server, the user as at least one category, based on personal information of the user, recommending, by the server, the pieces of content to the user, based on a frequency at which users included in the at least one category and different from the user pay for the pieces of content, and posting, by the terminal, the pieces of recommended content to the user.

According to an exemplary embodiment of the present disclosure, the method may further include displaying, by the vehicle control apparatus, content specified based on an input of a passenger of the vehicle through a user interface among pieces of content stored in the vehicle control apparatus on the display and providing, by the vehicle control apparatus, the passenger with a state in which the specified content is displayed on the display.

According to an exemplary embodiment of the present disclosure, the method may further include collecting or analyzing, by the server, information indicating the user and information related to details in which the user pays the price of the content.

According to an exemplary embodiment of the present disclosure, the transmitting of the paid content to the vehicle control apparatus by the server may include receiving, by the vehicle control apparatus, the paid content from the server via a vehicle communication device for performing wireless or wired communication of the vehicle.

According to an exemplary embodiment of the present disclosure, the method may further include uploading, by terminals of a plurality of sellers, the pieces of content for communication or expression to the server for sale.

According to an exemplary embodiment of the present disclosure, the method may further include, if the price of the selected content is free, transmitting, by the terminal, a request for obtaining the selected content to the server, without paying the price of the selected content, and transmitting, by the server, the selected content to the vehicle control apparatus, without providing the seller with the amount corresponding to the portion or all of the price.

According to an exemplary embodiment of the present disclosure, the method may further include uploading, by the terminal of the seller included in the terminals of the plurality of sellers, custom-made request content included in the pieces of content and requested from the user to the server or delivering, by the terminal of the seller included in the terminals of the plurality of sellers, the request content to the user.

According to another aspect of the present disclosure, a vehicle control apparatus may include a display, a vehicle communication device that performs wireless or wired communication of a vehicle including the vehicle control apparatus, and a processor. The processor may receive content for communication or expression, the content being selected and paid by a terminal of a user who utilizes the vehicle, via the vehicle communication device from a server of a platform, and display the paid content to the outside of the vehicle by the display.

According to an exemplary embodiment of the present disclosure, the processor may display content specified based on an input of a passenger of the vehicle through a user interface among pieces of content stored in the vehicle control apparatus on the display and may provide the passenger with whether the specified content is displayed on the display.

The methods and apparatuses of the present disclosure have other features and advantages which will be apparent from or are set forth in more detail in the accompanying drawings, which are incorporated herein, and the following Detailed Description, which together serve to explain predetermined principles of the present disclosure.

### BRIEF DESCRIPTION OF THE DRAWINGS

FIG. 1 is a block diagram illustrating a configuration of a system for providing an e-commerce service according to an exemplary embodiment of the present disclosure.

FIG. 2 is a block diagram illustrating a configuration of a vehicle control apparatus according to an exemplary embodiment of the present disclosure.

FIG. 3 illustrates an example of an interaction among a seller, a platform, and a user, in a vehicle control apparatus, a system for providing an e-commerce service, and a method for providing the e-commerce service according to an exemplary embodiment of the present disclosure;

FIG. 4 illustrates examples of content, in a vehicle control apparatus, a system for providing an e-commerce service, and a method for providing the e-commerce service according to an exemplary embodiment of the present disclosure.

FIG. 5 illustrates an example of signaling among a terminal of a seller, a server of a platform, a terminal of a user, and a vehicle control apparatus, in the vehicle control apparatus, a system for providing an e-commerce service, and a method for providing the e-commerce service according to an exemplary embodiment of the present disclosure.

FIG. 6 illustrates flow of an operation of a system for providing an e-commerce service for displaying paid content, in a vehicle control apparatus, the system for providing the e-commerce service, and a method for providing the e-commerce service according to an exemplary embodiment of the present disclosure.

FIG. 7 illustrates a determining system associated with a vehicle control apparatus, a system for providing an e-commerce service, and a method for providing the e-commerce service according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, predetermined dimensions, orientations, locations, and shapes will be determined in part by the particularly intended application and use environment.

In the figures, reference numbers refer to a same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical component is designated by the identical numerals even when they are displayed on other drawings. Furthermore, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Furthermore, in an exemplary embodiment of the present disclosure, the expression “greater than” or “less than” is used to determine whether a specific condition is satisfied or fulfilled, but is only to represent an example and does not exclude the description “greater than or equal to” or “less than or equal to”. A condition described as being “greater than or equal to” may be replaced with a condition described as being “greater than”, a condition describing as being “less than or equal to” may be replaced with a condition described as being “less than”, and a condition described as being “greater than or equal to and less than” may be replaced with “greater than and less than or equal to”. Furthermore, hereinafter, the expression “A to B” refers to at least one of elements (including B) from A to B (including A).

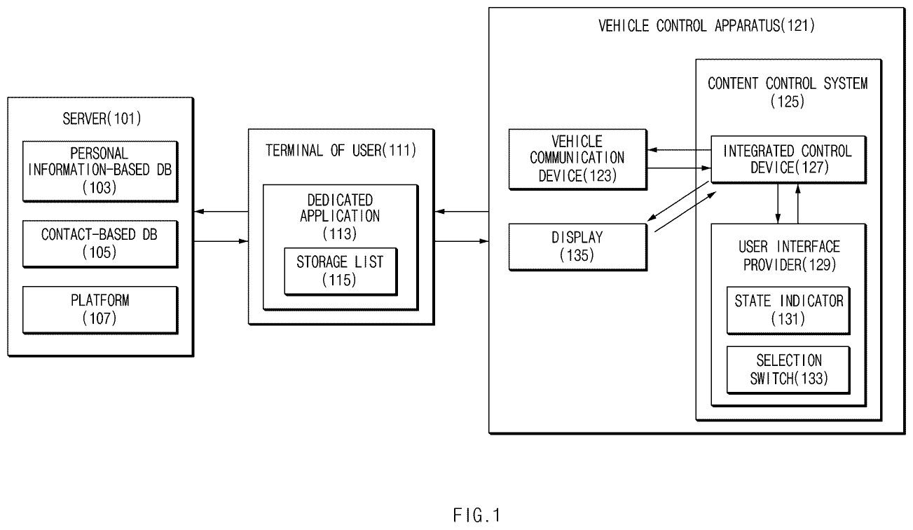

Hereinafter, examples of the present disclosure will be described in detail with reference to FIGS. 1 to 7.

FIG. 1 is a block diagram illustrating a configuration of a system for providing an e-commerce service according to an exemplary embodiment of the present disclosure.

Referring to FIG. 1, the system for providing the e-commerce may include a server 101, a terminal 111 of a user, and a vehicle control apparatus 121. The server 101 may provide a personal information-based database (DB) 103, a contact-based DB 105, and a platform 107. The server 101 may include a server of the platform 107. The terminal 111 of the user may include a dedicated application 113 which provides a storage list 115. The vehicle control apparatus 121 may include a vehicle communication device 123, a display 135, and a content control system 125. The content control system 125 may include an integrated control unit 127 and a user interface provider 129. The user interface provider 129 may include a state indicator 131 and a selection switch 133.

According to an exemplary embodiment of the present disclosure, the terminal 111 of the user may be a device for inputting and outputting information via a communication circuit. For example, the terminal 111 of the user may include a smartphone or may be included in a vehicle. However, aspects of the present disclosure may not be limited thereto.

According to an exemplary embodiment of the present disclosure, the vehicle control apparatus 121 may display content for communication or expression to an outside of the vehicle by a display of the vehicle.

According to an exemplary embodiment of the present disclosure, the content for communication or expression may include at least one of text, an image, or a video, or any combination thereof.

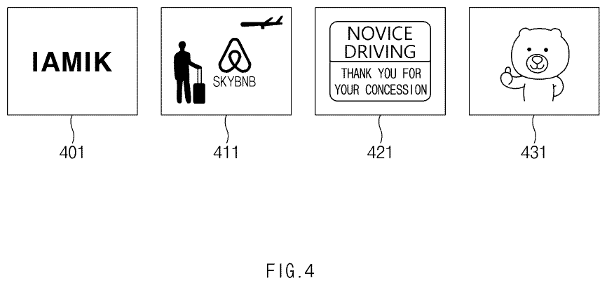

For example, the content may include an emoticon for delivering gratitude to a vehicle which gives way. For example, the content may include text for providing a notification that a driver of the vehicle is a novice driver. For example, the content may include an image indicating information for an advertisement. For example, the content may include text which is aesthetically processed by a font and a color. Detailed examples for the content will be described below with reference to FIG. 4.

According to an exemplary embodiment of the present disclosure, the vehicle control apparatus 121 may display content to identify the content from the outside of the vehicle by the display 135 attached to the outside of the vehicle. However, aspects of the present disclosure may not be limited thereto. For example, the vehicle control apparatus 121 may display content to identify the content from the outside of the vehicle by the display 135 provided in the vehicle to be shown from the outside thereof via a rear glass.

According to an exemplary embodiment of the present disclosure, the user who utilizes the vehicle may obtain content by the platform 107. For example, if the content is paid, the user may pay a price of the content to obtain the content. For another example, if the content is free, the user may obtain the content without paying the price of the content. If the content is displayed for an advertisement of a sponsor different from the user, the user may obtain a price of displaying the content.

According to an exemplary embodiment of the present disclosure, an operator of the platform 107 may obtain profits in a process of brokering and managing a transaction between a seller and the user. For example, the server 101 of the platform 107 may perform at least one of charging the user a fee, charging the seller the fee, or obtaining cost for an advertisement posted on the platform 107 from an advertiser, or any combination thereof, in a process of brokering and managing a transaction between the seller and the user. As an exemplary embodiment of the present disclosure, the server 101 of the platform 107 may add a certain percentage fee proportional to the paid price or may charge a certain amount of fee for each transaction between the user and the seller.

According to an exemplary embodiment of the present disclosure, the seller may upload content to the server 101 of the platform 107 to obtain a profit using the price of the content paid by the user.

According to an exemplary embodiment of the present disclosure, the system for providing the e-commerce service for providing content may post pieces of content for communication or expression, which are uploaded to the server 101, to the user by the terminal 111 (e.g., a smartphone or a computer) of the user, by the server 101. The operation of posting the pieces of content may include an operation of subscribing to a transaction. The operation of posting the pieces of content may include an operation of providing the user with pieces of content for subscribing for a purchase.

According to an exemplary embodiment of the present disclosure, the operation of the terminal 111 of the user may be performed based on the execution of the dedicated application 113. In other words, the terminal 111 of the user may provide the user with the pieces of posted content, based on the execution of the dedicated application 113.

According to an exemplary embodiment of the present disclosure, the server 101 of the platform 107 may obtain a profit in a process of brokering and managing a transaction between the seller and the user.

According to an exemplary embodiment of the present disclosure, the server 101 of the platform 107 may store personal information obtained from the terminal 111 of the user in the personal information-based DB 103 and may store a contact obtained from the terminal 111 of the user in the contact-based DB 105.

According to an exemplary embodiment of the present disclosure, the server 101 of the platform 107 may identify the user by the personal information and may be configured to generate an account of the user. The server 101 of the platform 107 may register an image obtained from the terminal 111 of the user as a profile photo in the account of the user. The server 101 of the platform 107 may provide a function of sharing or recommending content to another user, based on the contact obtained from the terminal 111 of the user, which is registered in the account of the user. The server 101 of the platform 107 may provide a function of adding or recommending the other user as a friend.

According to an exemplary embodiment of the present disclosure, the terminal 111 of the user may pay a price of content selected by a user input among the pieces of posted content. The user may select content depending on the purpose of using the content.

According to an exemplary embodiment of the present disclosure, the price of the content may be paid. The terminal 111 of the user may transmit a request for obtaining the paid content to the server 101. According to an exemplary embodiment of the present disclosure, the server 101 may provide the seller who uploads the pieces of paid content to the server 101 with an amount corresponding to a portion or all of the price. The server 101 may transmit the paid content to the vehicle control apparatus 121. However, aspects of the present disclosure may not be limited thereto. For example, the server 101 may transmit the paid content to the terminal 111 of the user. The terminal 111 of the user may transmit the obtained content to the vehicle control apparatus 121.

According to an exemplary embodiment of the present disclosure, providing the seller who uploads the paid content with the amount may include transferring money corresponding to the amount to an account of the seller. However, aspects of the present disclosure may not be limited thereto. According to an exemplary embodiment of the present disclosure, providing the amount corresponding to the portion or all of the price in an exemplary embodiment of the present disclosure may include providing the seller with the amount corresponding to the portion or all of the price as mileage, points, a service, cash, benefits, virtual currency, or an equivalent corresponding to the monetary value of the amount. According to another exemplary embodiment of the present disclosure, the price of the content may be free. If the price of the selected content is free, the terminal 111 of the user may transmit a request for obtaining the selected content to the server 101, without paying the price of the selected content. The server 101 may transmit the selected content to the vehicle control apparatus 121, without providing the seller with the amount corresponding to the portion or all of the price. However, aspects of the present disclosure may not be limited thereto. For example, the server 101 may transmit the selected content to the terminal 111 of the user. The terminal 111 of the user may transmit the obtained content to the vehicle control apparatus 121.

According to an exemplary embodiment of the present disclosure, if the price of the content is free, if the selected content is for an advertisement of a sponsor different from the user (e.g., if the selected content includes at least one of a symbol for a profit of the user from sponsored advertising, text for a profit of the user from sponsored advertising, image for a profit of the user from sponsored advertising, or sound for a profit of the user from sponsored advertising, or any combination thereof), the terminal 111 of the user may transmit a request for obtaining the selected content to the server 101, without paying the price of the selected content. The server 101 may provide the user registered in the terminal 111 of the user with a price of displaying the selected content on the display 135, without providing the seller with the amount corresponding to the portion or all of the price.

According to an exemplary embodiment of the present disclosure, providing the user registered in the terminal 111 of the user with the price of displaying the selected content may include transferring the money corresponding to the price to the account of the user or paying the account of the user the money corresponding to the price as benefits (e.g., applying a discount promotion if purchasing a product or service of the sponsor). However, aspects of the present disclosure may not be limited thereto. According to an exemplary embodiment of the present disclosure, providing the user with the price may include providing the seller with the amount corresponding to the price as mileage, points, a service, cash, benefits, virtual currency, or an equivalent corresponding to the monetary value of the amount.

According to an exemplary embodiment of the present disclosure, the operation of the terminal 111 of the user may be performed based on the execution of the dedicated application 113. In other words, based on the execution of the dedicated application 113, the terminal 111 of the user may pay the price of the content and may transmit a request for obtaining the paid content to the server 101, if the price of the content is paid, or may transmit the request for obtaining the selected content to the server 101, if the price of the content is free.

According to an exemplary embodiment of the present disclosure, the terminal 111 of the user may provide the user with the storage list 115 including the pieces of stored content, based on the execution of the dedicated application 113.

According to an exemplary embodiment of the present disclosure, if installing the dedicated application 113 in the terminal 111 of the user, the user may communicate with the content control system 125 by the dedicated application 113. The terminal 111 of the user may be configured for controlling the content control system 125 by the vehicle control device 123 of the vehicle control apparatus 121. According to an exemplary embodiment of the present disclosure, the dedicated application 113 may obtain personal information such as a photo or a contact of the user. According to an exemplary embodiment of the present disclosure, the dedicated application 113 may provide the user with pieces of recommended content, based on the personal information stored in a Bluelink link method.

According to an exemplary embodiment of the present disclosure, the vehicle control apparatus 121 may store content received via the integrated control unit 127 or may display the content received via the integrated control unit 127 on the display 135.

According to an exemplary embodiment of the present disclosure, the vehicle control apparatus 121 may pay for the selected content by the vehicle communication device 123 or may obtain the selected content by the vehicle communication device 123. The vehicle control apparatus 121 may select whether to display the paid or selected content on the display 135 by the content control system 125.

For example, the vehicle control apparatus 121 may select content to be displayed based on an input of a passenger of the vehicle by the user interface provider 129 among pieces of content stored in the vehicle control apparatus 121. The user interface provider 129 may include the selection switch 133.

For example, the vehicle control apparatus 121 may provide a passenger with a state in which specified content is displayed on the display 135, by the user interface provider 129. The user interface provider 129 may include the state indicator 131.

According to an exemplary embodiment of the present disclosure, the vehicle control apparatus 121 may display the paid or selected content to the outside of the vehicle by the display 135. By the content displayed to the outside of the vehicle, the user may obtain profits, may indicate his or her intention, may ensure safety, or may perform decoration or styling of the vehicle. Furthermore, the vehicle control apparatus 121 may display content for various purposes.

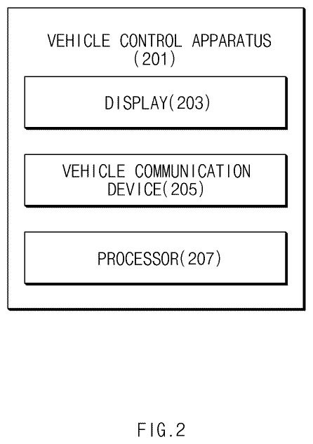

FIG. 2 is a block diagram illustrating a configuration of a vehicle control apparatus according to an exemplary embodiment of the present disclosure.

Referring to FIG. 2, a vehicle control apparatus 201 may include a display 203, a vehicle communication device 205, and a processor 207.

According to an exemplary embodiment of the present disclosure, the vehicle communication device 205 may perform wireless or wired communication of a vehicle including the vehicle control apparatus 201. The processor 207 may receive content for communication or expression, which is selected and paid by a terminal of a user who utilizes a vehicle, via a vehicle communication device 205 from a server of a platform and may display the paid content to the outside of the vehicle by the display 203.

The vehicle communication device 205 may establish wired or wireless communication channels between the vehicle and external devices (e.g., other vehicles or servers). The vehicle communication device 205 may include one or more independent communication processors to manage the wired or wireless communication channels. The vehicle communication device 205 may include a wireless communication module, such as a cellular module supporting 4G and 5G networks, or a short-range communication module for Bluetooth or Wi-Fi. The vehicle communication device 205 may include a wired communication module support LAN or power line communication (PLC). The vehicle communication device 205 may receive content for communication or expression. The communication modules may be integrated into a single component or implemented as separate components.

According to an exemplary embodiment of the present disclosure, the vehicle control apparatus 201 may receive the paid content from the server, via the vehicle communication device 205 which performs wireless or wired communication of the vehicle.

According to an exemplary embodiment of the present disclosure, the processor 207 may display content specified based on an input of a passenger of the vehicle through a user interface among pieces of content stored in the vehicle control apparatus 201 on the display 203 and may provide the passenger with whether the specified content is displayed on the display 203.

The display 203 may include an LED or OLED screen capable of showing images for clear visibility in various lighting conditions. The display 203 may also support content for communication or expression, such as advertisements, and emoticon. The display 203 may be durable and resistant to environmental factors such as temperature fluctuations and vibrations.

The user interface controlling the display 203 may support interactive features such as gesture recognition and voice commands to enhance user interaction. The user interface may be provided through displays different from the display 203.

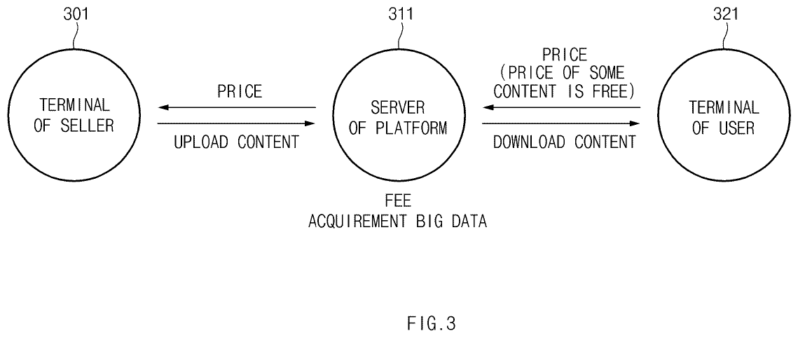

FIG. 3 illustrates an example of an interaction among a seller, a platform, and a user, in a vehicle control apparatus, a system for providing an e-commerce service, and a method for providing the e-commerce service according to an exemplary embodiment of the present disclosure.

Referring to FIG. 3, the e-commerce service may be performed by a terminal 301 of a seller, a server 311 of a platform, and a terminal 321 of a user.

According to an exemplary embodiment of the present disclosure, the terminal 301 of the seller may upload content to the server 311 of the platform. The seller may obtain a price of the content depending on a contract between the seller and the platform. The price of the content may be paid, if the content is uploaded according to the contract between the seller and the platform, and may be paid according to the number of times the user pays the price of the content or a frequency of use of the content. However, aspects of the present disclosure may not be limited thereto.

According to an exemplary embodiment of the present disclosure, the system for providing the e-commerce service may further include terminals 301 of a plurality of sellers. The terminals 301 of the sellers may upload pieces of content for communication or expression to the server 311 of the platform for sale. According to an exemplary embodiment of the present disclosure, the terminals 301 of the sellers may upload a custom-made request content requested by the user to the server 311 of the platform or may deliver the request content to the user. The sellers may reflect requests of users to produce individually generated request content.

According to an exemplary embodiment of the present disclosure, the server 311 of the platform may broker and manage a transaction between the seller and the user.

In a process of brokering and managing the transaction, the server 311 of the platform may charge the user a fee, may charge the seller the fee, or may obtain cost for an advertisement posted on the platform from an advertiser. The advertisement posted on the platform may be posted in an application operated by the platform and may be targeted at the user or the seller.

According to an exemplary embodiment of the present disclosure, the server 311 of the platform may ensure big data for content. In other words, the server 311 of the platform may collect or analyze one of information indicating the user (e.g., user identifier, user age group, user gender), information related to details in which the user pays a price of content (e.g., payment frequency, number of payment, payment amount), information related to details in which the user clicks on content (e.g., click frequency), or information related to details in which the user expresses interest in content (e.g., list of content added to user's interests), or any combination thereof.

The server 311 of the platform may sell or use big data for content. For example, the server 311 of the platform may classify the user as at least one category, based on personal information (e.g., a gender, an age, or a job) of the user and may recommend pieces of content to the user, based on a frequency at which users included in the at least one category and different from the user (e.g., the users with a same gender as the user, users with a same age as the user, or users with a same job as the user) pay for the pieces of content. The server 311 of the platform may deliver information related to the pieces of recommended content to the terminal 321 of the user, thus posting the pieces of recommended content to the user.

According to an exemplary embodiment of the present disclosure, the server 311 of the platform may select and manage pieces of uploaded content and may post the pieces of uploaded content on the terminal 321 of the user for transaction. For example, the server 311 of the platform may post pieces of content, except for pieces of content which distracts other drivers to causes an accident, causes disgust, or harms public order and morals, on the terminal 321 of the user for transaction. Furthermore, the server 311 of the platform may provide regulations and guidelines for content transactions. The server 311 of the platform may charge the user an operating expense to be paid to use an application or may charge the seller the operating expense, as a price of operating an application.

According to an exemplary embodiment of the present disclosure, the terminal 321 of the user may upload content from the server 311 of the platform. According to an exemplary embodiment of the present disclosure, the content may be downloaded from the server 311 of the platform to a vehicle control apparatus. However, aspects of the present disclosure may not be limited thereto. According to an exemplary embodiment of the present disclosure, the content may be downloaded from the server 311 of the platform to the terminal 321 of the user and may then be downloaded from the terminal 321 of the user to the vehicle control apparatus.

According to an exemplary embodiment of the present disclosure, if the price of the content is paid, the terminal 321 of the user may pay the price by the server 311 of the platform. If the price of the content is free, the terminal 321 of the user may fail to pay the price by the server 311 of the platform. If the content is displayed for an advertisement of a sponsor different from the user, the user may obtain a price of displaying the content. The price may be provided to the user registered in the terminal 321 of the user. For example, the price may be provided to the user registered in the terminal 321 of the user. For example, if the sponsor is a shared accommodation platform company, a benefit may include a benefit of applying a discount promotion if booking an accommodation of the sponsor. For another example, if the sponsor is an insurance company, the benefit may include a benefit of supporting an auto insurance, if signing up for the auto insurance of the sponsor.

FIG. 4 illustrates examples of content, in a vehicle control apparatus, a system for providing an e-commerce service, and a method for providing the e-commerce service according to an exemplary embodiment of the present disclosure.

Referring to FIG. 4, first content 401 may include text indicating a model name of a vehicle for the decoration of the vehicle. Second content 411 may include a symbol and information indicating an advertisement of a sponsor different from a user for a profit of the user. Third content 421 may include a novice driving warning sign indicated for safety. Fourth content 431 may include an emoticon for displaying gratitude which is the intention of the user.

According to an exemplary embodiment of the present disclosure, content (e.g., the first content 401, the second content 411, the third content 421, and the fourth content 431) for communication or expression may include at least one of text, an image, or a video, or any combination thereof.

According to an exemplary embodiment of the present disclosure, the content (e.g., the first content 401) for communication or expression may include a symbol or information for performing decoration or styling of the vehicle. For example, the content may include text which is aesthetically processed by a font and a color. For example, the content may include an image of a popular artist. For example, the content may include an image of a pet. For example, the content may include text including a sentence of a literary work. For example, the content may include text indicating a wise saying. For example, the content may include an image of a character. For example, the content may include an emoticon with an animation effect. For example, the content may include move art including a logo of a company or product.

According to an exemplary embodiment of the present disclosure, the content (e.g., the second content 411) for communication or expression may include a symbol or information for a profit of the user. For example, the content may include a video indicating information for an advertisement. For example, the content may include an image and a quick response (QR) code for advertising business of a sponsor. For example, the content may include a number of a character code for promotion.

According to an exemplary embodiment of the present disclosure, the content (e.g., the third content 421) for communication or expression may include a symbol or information associated with safety. For example, the content may include text for providing a notification that a driver of the vehicle is a novice driver. For example, the content may include text or an image for providing a notification that a pet is riding. For example, the content may include text or an image for providing a notification that a transportation disadvantaged person is riding. For example, the content may include an animation effect in text the user wants to highlight.

According to an exemplary embodiment of the present disclosure, the content for communication or expression may include a symbol or information indicating an intention of the user. For example, the content may include an emoticon for delivering gratitude to a vehicle which gives way. For example, the content may include an emoticon for delivering sorry. For example, the content may add an animation effect to the emoticon. For example, the content may include an image for providing a notification of a lane change.

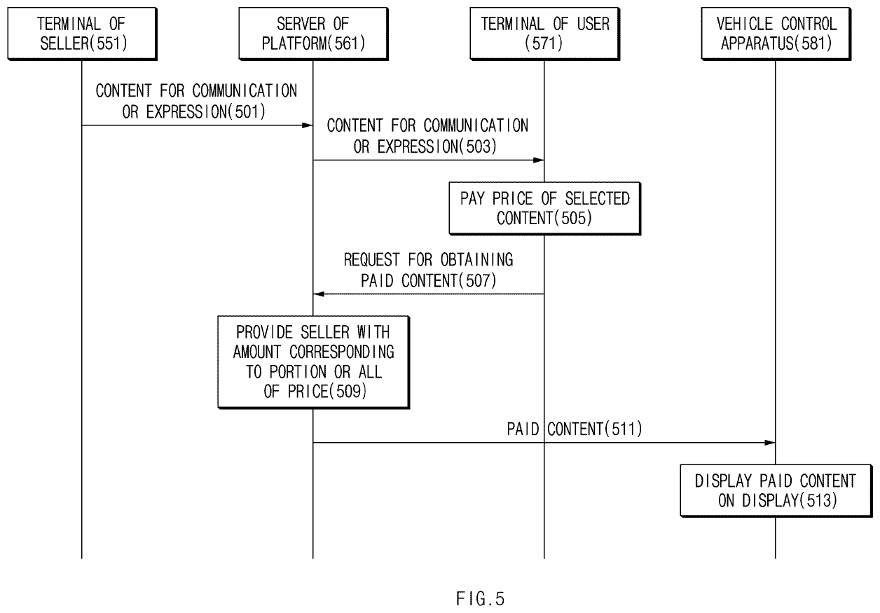

FIG. 5 illustrates an example of signaling among a terminal of a seller, a server of a platform, a terminal of a user, and a vehicle control apparatus, in the vehicle control apparatus, a system for providing an e-commerce service, and a method for providing the e-commerce service according to an exemplary embodiment of the present disclosure.

Hereinafter, it is assumed that a server 101, a terminal 111 of a user, and a vehicle control apparatus 121 of FIG. 1 or a vehicle control apparatus 201 of FIG. 2 performs a process of FIG. 5. Furthermore, in a description of FIG. 5, an operation referred to as being performed by a vehicle control apparatus may be understood as being controlled by a processor 207 of the vehicle control apparatus 201.

Referring to FIG. 5, in a first operation 501, according to an exemplary embodiment of the present disclosure, a terminal 551 of a seller may transmit content for communication or expression to a server 561 of a platform to upload the content to the server 561 of the platform. The server 561 of the platform may receive the content from the terminal 551 of the seller to upload the content to the server 561 of the platform.

In a second operation 503, according to an exemplary embodiment of the present disclosure, the server 561 of the platform may transmit the content for communication or expression to a terminal 571 of a user to post the content to the user. The terminal 571 of the user may receive the content for communication or expression from the server 561 of the platform to post the content to the user.

In a third operation 505, according to an exemplary embodiment of the present disclosure, the terminal 571 of the user may pay a price of selected content. The selected content may be selected by a user input among pieces of content for communication or expression, which are posted to the user by the server 561 of the platform.

In a fourth operation 507, according to an exemplary embodiment of the present disclosure, the terminal 571 of the user may transmit a request for obtaining paid content to the server 561 of the platform. The server 561 of the platform may receive the request for obtaining the paid content from the terminal 571 of the user.

In a fifth operation 509, according to an exemplary embodiment of the present disclosure, the server 561 of the platform may provide a seller with an amount corresponding to a portion or all of the price. The seller may include a person who uploads the paid content.

In a sixth operation 511, according to an exemplary embodiment of the present disclosure, the server 561 of the platform may transmit the paid content to a vehicle control apparatus 581. The vehicle control apparatus 581 may receive the paid content from the server 561 of the platform.

According to an exemplary embodiment of the present disclosure, an order in which the fifth operation 509 and the sixth operation 511 are performed may be changed. According to an exemplary embodiment of the present disclosure, the server 561 of the platform may perform the sixth operation 511 and may then perform the fifth operation 509.

In a seventh operation 513, according to an exemplary embodiment of the present disclosure, the vehicle control apparatus 581 may display the paid content on a display. In other words, the vehicle control apparatus 581 may display the paid content to the outside of the vehicle by the display of a vehicle.

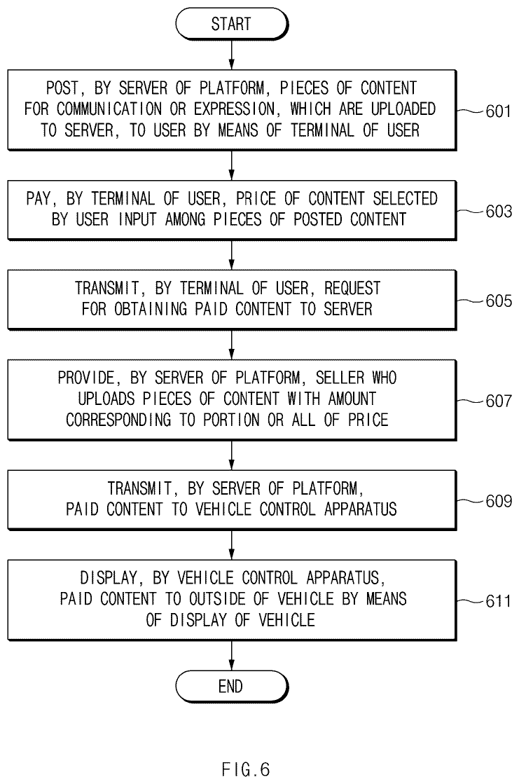

FIG. 6 illustrates flow of an operation of a system for providing an e-commerce service for displaying paid content, in a vehicle control apparatus, the system for providing the e-commerce service, and a method for providing the e-commerce service according to an exemplary embodiment of the present disclosure.

Hereinafter, it is assumed that a server 101, a terminal 111 of a user, and a vehicle control apparatus 121 of FIG. 1 or a vehicle control apparatus 201 of FIG. 2 performs a process of FIG. 6. Furthermore, in a description of FIG. 6, an operation referred to as being performed by a vehicle control apparatus may be understood as being controlled by a processor 207 of the vehicle control apparatus 201.

In a first operation 601, according to an exemplary embodiment of the present disclosure, a server of a platform may post pieces of content for communication or expression, which are uploaded to the server, to a user by a terminal of the user.

In a second operation 603, according to an exemplary embodiment of the present disclosure, the terminal of the user may pay a price of content selected by a user input among the pieces of posted content.

In a third operation 605, the terminal of the user may transmit a request for obtaining the paid content to the server.

In a fourth operation 607, according to an exemplary embodiment of the present disclosure, the server of the platform may provide a seller who uploads the paid content with an amount corresponding to a portion or all of the price.

In a fifth operation 609, according to an exemplary embodiment of the present disclosure, the server of the platform may transmit the paid content to a vehicle control apparatus.

In a sixth operation 611, according to an exemplary embodiment of the present disclosure, the vehicle control apparatus may display the paid content to an outside of the vehicle by a display of the vehicle.

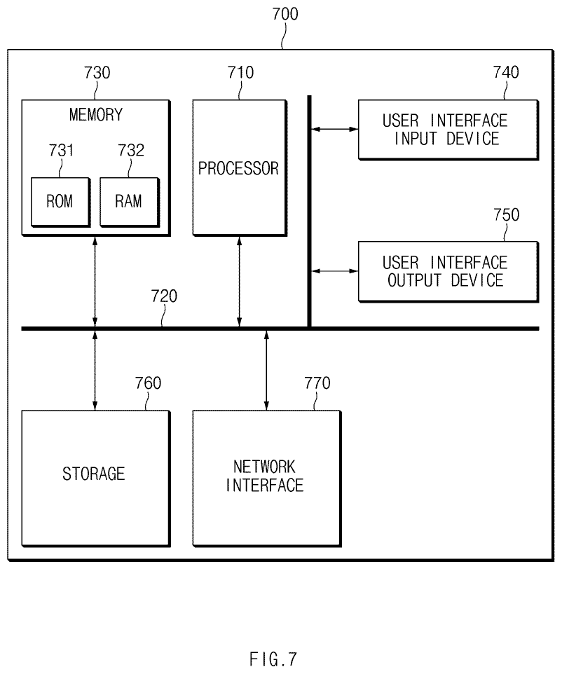

FIG. 7 illustrates a computing system associated with a vehicle control apparatus, a system for providing an e-commerce service, and a method for providing the e-commerce service according to an exemplary embodiment of the present disclosure.

Referring to FIG. 7, a computing system 700 may include at least one processor 710, a memory 730, a user interface input device 740, a user interface output device 750, storage 760, and a network interface 770, which are connected to each other via a bus 720.

The processor 710 may be a central processing unit (CPU) or a semiconductor device that processes instructions stored in the memory 730 and/or the storage 760. The memory 730 and the storage 760 may include various types of volatile or non-volatile storage media. For example, the memory 730 may include a read only memory (ROM) 731 and a random access memory (RAM) 732.

Accordingly, the operations of the method or algorithm described in connection with the exemplary embodiments included in the specification may be directly implemented with a hardware module, a software module, or a combination of the hardware module and the software module, which is executed by the processor 710. The software module may reside on a storage medium (that is, the memory 730 and/or the storage 760) such as a RAM, a flash memory, a ROM, an EPROM, an EEPROM, a register, a hard disc, a removable disk, and a CD-ROM.

The exemplary storage medium may be coupled to the processor 710. The processor 710 may read out information from the storage medium and may write information in the storage medium. Alternatively, the storage medium may be integrated with the processor 710. The processor and the storage medium may reside in an application specific integrated circuit (ASIC). The ASIC may reside within a user terminal. In another case, the processor and the storage medium may reside in the user terminal as separate components.

The present technology may transact content displayed on the vehicle.

Furthermore, the present technology may transact content for communication or expression, which is effective and emotional.

Furthermore, the present technology may allow the platform to ensure a profit by brokering the transaction of content displayed on the vehicle.

Furthermore, the present technology may allow the platform to ensure big data by brokering the transaction of content displayed on the vehicle.

Furthermore, the present technology may ensure a communication ecosystem between vehicles by brokering the transaction of content displayed on the vehicle.

Furthermore, the present technology may allow a seller to ensure a profit by selling content displayed on the vehicle.

Furthermore, the present technology may allow a user to ensure a profit by advertising content displayed on the vehicle.

Furthermore, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of at least one of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for providing an e-commerce service through communication in a terminal of a user who utilizes a vehicle including a vehicle control apparatus and a server of a platform, the method including:
posting, by the server, pieces of content for communication or expression, the pieces of content being uploaded to the server, to the user by the terminal;
paying, by the terminal, a price of content selected by a user input among the pieces of posted content;
transmitting, by the terminal, a request for obtaining the paid content to the server;
providing, by the server, a seller who uploads the paid content with an amount corresponding to a portion or all of the price;
transmitting, by the server, the paid content to the vehicle control apparatus; and
displaying, by the vehicle control apparatus, the paid content to an outside of the vehicle by a display of the vehicle.

2. The method of claim 1, wherein the paying of the price of the content selected by the user input among the pieces of posted content by the terminal includes:
paying, by the terminal, the price of the content selected by the user input among the pieces of content including at least one of a symbol indicating an intention of the user, information indicating the intention of the user, a symbol associated with safety, information associated with the safety, a symbol for a profit of the user, information for the profit of the user, a symbol for performing decoration or styling of the vehicle, or information for performing the decoration or the styling of the vehicle, or any combination thereof.

3. The method of claim 1, further including:
in response that the selected content includes at least one of a symbol for a profit of the user or information for the profit of the user, or any combination thereof:
transmitting, by the terminal, a request for obtaining the selected content to the server, without paying the price of the selected content; and
providing, by the server, the user registered in the terminal with a price of displaying the selected content on the display, without providing the seller with the amount corresponding to the portion or all of the price.

4. The method of claim 1, further including:
performing, by the server, at least one of charging the user a fee, charging the seller the fee, or obtaining cost for an advertisement posted on the platform from an advertiser, or any combination thereof, in a process of brokering and managing a transaction between the seller and the user.

5. The method of claim 1, wherein the paying of the price of the content selected by the user input among the pieces of posted content by the terminal includes:
paying, by the terminal, the price of the content selected by the user input, based on execution of an application for providing the content, and
wherein the transmitting of the request for obtaining the paid content to the server by the terminal includes:
transmitting, by the terminal, the request for obtaining the paid content to the server, based on the execution of the application.

6. The method of claim 1, wherein the posting of the pieces of content for communication or expression, the pieces of content being uploaded to the server, to the user by the terminal by the server includes:
classifying, by the server, the user as at least one category, based on personal information of the user;
recommending, by the server, the pieces of content to the user, based on a frequency at which users included in the at least one category and different from the user pay for the pieces of content; and
posting, by the terminal, the pieces of recommended content to the user.

7. The method of claim 1, further including:
displaying, by the vehicle control apparatus, content specified based on an input of a passenger of the vehicle through a user interface among pieces of content stored in the vehicle control apparatus on the display; and
providing, by the vehicle control apparatus, the passenger with a state in which the specified content is displayed on the display.

8. The method of claim 1, further including:
collecting or analyzing, by the server, information indicating the user and information related to details in which the user pays the price of the content.

9. The method of claim 1, wherein the transmitting of the paid content to the vehicle control apparatus by the server includes:
receiving, by the vehicle control apparatus, the paid content from the server via a vehicle communication device for performing wireless or wired communication of the vehicle.

10. The method of claim 1, further including:
uploading, by terminals of a plurality of sellers, the pieces of content for communication or expression to the server for sale.

11. The method of claim 1, further including:
in response that the price of the selected content is free:
transmitting, by the terminal, a request for obtaining the selected content to the server, without paying the price of the selected content; and
transmitting, by the server, the selected content to the vehicle control apparatus, without providing the seller with the amount corresponding to the portion or all of the price.

12. The method of claim 10, further including:
uploading, by the terminal of the seller included in the terminals of the plurality of sellers, to the server, custom-made request content included in the pieces of content and requested from the user or delivering, by the terminal of the seller included in the terminals of the plurality of sellers, the request content to the user.

13. A vehicle control apparatus, comprising:
a display;
a vehicle communication device configured to perform wireless or wired communication of a vehicle including the vehicle control apparatus; and
a processor,
wherein the processor is configured to:
receive content for communication or expression, the content being selected and paid by a terminal of a user who utilizes the vehicle, via the vehicle communication device from a server of a platform; and
display the paid content to the outside of the vehicle by the display.

14. The vehicle control apparatus of claim 13, wherein the processor is further configured to:
display content specified based on an input of a passenger of the vehicle through a user interface among pieces of content stored in the vehicle control apparatus on the display; and
provide the passenger with whether the specified content is displayed on the display.

15. A system for providing an electronic commerce (e-commerce) service associated with a vehicle control apparatus, the system comprising:
a terminal of a user who utilizes a vehicle including the vehicle control apparatus; and
a server of a platform,
wherein the terminal is configured to:
pay a price of content selected by a user input among pieces of content for communication or expression, the pieces of content posted to the user by the server; and
transmit a request for obtaining the paid content to the server,
wherein the server is configured to:
post pieces of content uploaded to the server to the user by the terminal;
provide a seller who uploads the paid content with an amount corresponding to a portion or all of the price; and
transmit the paid content to the vehicle control apparatus, and
wherein the vehicle control apparatus is configured to:
display the paid content to an outside of the vehicle by a display of the vehicle.

16. The system of claim 15, wherein the terminal is further configured to:
pay the price of the selected content among the pieces of content including at least one of a symbol indicating an intention of the user, information indicating the intention of the user, a symbol associated with safety, information associated with the safety, a symbol for a profit of the user, information for the profit of the user, a symbol for performing decoration or styling of the vehicle, or information for performing the decoration or the styling of the vehicle, or any combination thereof.

17. The system of claim 15, wherein, in response that the selected content includes at least one of a symbol for a profit of the user or information for the profit of the user, or any combination thereof:
the terminal is further configured to transmit a request for obtaining the selected content to the server, without paying the price of the selected content, and the server is further configured to provide the user registered in the terminal with a price of displaying the selected content on the display, without providing the seller with the amount corresponding to the portion or all of the price.

18. The system of claim 15, wherein the server is further configured to:
perform at least one of charging the user a fee, charging the seller the fee, or obtaining cost for an advertisement posted on the platform from an advertiser, or any combination thereof, in a process of brokering and managing a transaction between the seller and the user.

19. The system of claim 15, wherein the terminal is further configured to:
pay the price of the content selected by the user input, based on execution of an application for providing the content; and
transmit the request for obtaining the paid content to the server, based on the execution of the application.

20. The system of claim 15, wherein the server is further configured to:
classify the user as at least one category, based on personal information of the user; and
recommend the pieces of content to the user, based on a frequency at which users included in the at least one category and different from the user pay for the pieces of content, and
wherein the terminal is further configured to post the pieces of the recommended content to the user.
